(19) United States
(12) Patent Application Publication
(10) Pub. No.: US 2004/0227271 A1
(43) Pub. Date: Nov. 18, 2004

(54) Method of double color-molding a key top

(75) Inventors: Masanori Takebe, Tokyo (JP); Takashi Odagiri, Tokyo (JP)

Correspondence Address: MORGAN LEWIS & BOCKIUS LLP, 1111 PENNSYLVANIA AVENUE NW, WASHINGTON, DC, 20004, US

(73) Assignee: Uniden Corporation

(21) Appl. No.: 10/727,984

(22) Filed: Dec. 5, 2003

(30) Foreign Application Priority Data
May 14, 2003 (JP) 2003-136339

(51) Int. Cl. B29C 45/16

(52) U.S. Cl. 264/255

(57) ABSTRACT

An object of the present invention is to provide a method of double color-molding a key top, which is superior in design. In order to achieve this object, according to the method of double color-molding a key top provided in the present invention, at a first shot, an outer part that forms an outer line of a closed loop in a letter, figure, mark, etc., and an inner part that forms an inner line of the closed loop, are injection-molded with light-shielding resin using light-shielding resin. At a second shot, a light-permeable resin layer is injection-molded in such a manner that it covers a gate trace formed on both the outer part and the inner part. When light-permeable resin is used for the light-permeable resin layer, the gate trace is hardly invisible when the back light is off.

### BACKGROUND

1. Field of the Invention

The present invention relates to a technology of double color-molding a key top that is used for inputs in various kinds of electric devices, such as mobile phones, telephone machines, facsimile machines, copiers, car stereos, car radios, and remote controllers.

2. Description of the Related Art

FIG. 8 is a plane view of a conventional double color-molded key top, and FIG. 9 is a cross-sectional view along the line 9-9 of FIG. 8. A key top 100 shown in these figures, which is molded in order to indicate the numeral “0” of a push button for a telephone machine, has a bilayer structure consisting of a light-shielding resin layer (non-light-transmittable layer) 80 and a light-permeable resin layer (light-transmittable layer) 90. The light-shielding resin layer 80 comprises: an outer part 80a to form an outer line of a numeral “0” which forms a closed curve; an inner part 80b to form an inner line of the numeral “0”; and an arm-shaped bridge 80c which connects both parts. A closed loop 101, which is in the shape of a closed curve-defined by the outer part 80a and an inner part 80b, is filled with the light-permeable resin layer 90, and is constructed so that it is illuminated by a backlight to light up and indicate a numeral

In order to double color-mold a key top having such structure, a mold having a slide mechanism has been provided, and a hollow flow path to connect the outer part 80a and the inner part 80b has been formed using the sliding mechanism, and the light-permeable resin has been injected into the hollow flow path, thereby injection-molding the light-shielding resin layer 80 comprising the outer part 80a, the inner part 80b and the bridge 80c in one injection.

As shown in FIG. 8, however, the bridge 80c is injection-molded in such a manner that it passes behind the light-permeable resin layer 90 with which the closed loop 101 is filled. Therefore, there has been a problem that, when illuminated by a backlight, this bridge portion causes a shadow, resulting in a poor quality image, which is unfavorable in terms of design. This problem arises in double-color molding a key top for indicating not only the above numeral “0,” but also a letter, figure, sign, etc., having a closed loop, including alphabets such as “A,” “B” and “O,” Arabic numerals such as “4,” “6” and “8,” and signs such as “Δ, “∘” and “□.” As means for solving such problem, Patent Laid-Open Publication No. Hei 7-88884 and Patent Laid-Open Publication No. Hei 7-1506 provide technologies for double color-molding a key top using a metal mold having a special structure.

However, in the technologies described in Laid-Open Publication No. Hei 7-88884 and Patent Laid-Open Publication No. Hei 7-1506, the metal mold has a complicated structure.

### SUMMARY

Therefore, an object of the present invention is to resolve the aforementioned problem and provide a method of double color-molding a key top that is superior in design.

In order to solve the aforementioned problem, the method of double color-molding a key top according to the present invention, comprises the steps of: performing a first shot for injection-molding with light-shielding resin an outer part that forms an outer line of a closed loop in a letter, figure, mark, etc., and an inner part that forms an inner line of the closed loop; performing a gate-cut of an injection gate for light-shielding resin in both the outer part and the inner part; and performing a second shot for injection-molding a light-permeable resin layer that contacts a surface of each of the outer part and the inner part in such a manner that the light-permeable resin layer covers a gate trace in each of the outer part and the inner part, which remains after the gate-cut.

By injection-molding the light-permeable layer in such a manner that it covers a gate trace remaining in both the outer part and the inner part of the light-shielding layer at the gate-cut, the gate trace can be made inconspicuous, which is favorable in terms of design.

The method of double color-molding a key top according to the present invention comprises the steps of: closing an upper metal mold for a first shot including a plurality of gate holes, which are arranged so that they are connected to a cavity, for injecting light-shielding resin into an outer part that forms an outer line of a closed loop in a letter, figure, mark, etc., and into an inner part that forms an inner line of the closed loop, and a lower metal mold having a core, which includes a convex portion that corresponds to a planer shape of the closed loop; performing a first shot for injecting light-shielding resin through the plurality of gate holes into a space remaining between the cavity of the upper metal mold and the core of the lower metal mold to injection-mold the inner part and the outer part; opening the upper metal mold for a first shot and the lower metal mold; and performing a gate cut of an injection gate of light-shielding resin in both the outer part and the inner part; changing the upper metal mold for a first shot to an upper metal mold for a second shot and the lower metal mold; closing the upper metal mold for a second shot and the lower metal mold; and injecting light-permeable resin into a space remaining between a cavity of the upper metal mold for a second shot and the lower metal mold to injection-mold a light-permeable resin layer in such a manner that it covers a gate trace in both of the inner part and the outer part remaining after the gate-cut.

A preferable height of the convex portion formed on the core is approximately half of a thickness of the inner part or the outer part. In this way, the force of bonding the light-shielding resin layer and the light-permeable resin layer at the second injection molding can be enhanced, which enables preventing the opening of both layers when the upper metal mold for a second shot and the lower metal mold are opened.

Here, a preferable example of light-permeable resin layers is a light-permeable chromatic resin layer, which selectively allows an emission wavelength of a back light through. In this way, when a back light is turned on, it is possible to light up only the letter, figure, mark, etc., portion of the key top, and when a back light is off, it is also possible to make a gate hole inconspicuous.

### DESCRIPTION OF DRAWINGS

FIG. 1 illustrates a key top molding procedure of this embodiment.

FIG. 2 illustrates a key top molding procedure of this embodiment.

FIG. 3 illustrates a key top molding procedure of this embodiment.

FIG. 4 illustrates a key top molding procedure of this embodiment.

FIG. 5 is a plane view of a light-shielding resin layer according to this embodiment.

FIG. 6 is a plane view of a key top according to this embodiment.

FIG. 7 is a cross-sectional view along the 7-7 line in FIG. 6.

FIG. 8 is a plane view of a conventional key top.

FIG. 9 is a cross-sectional view along the 9-9 line in FIG. 8.

### DESCRIPTION OF THE PREFERRED EMBODIMENT

A preferred embodiment of the present invention is explained below with reference to the drawings.

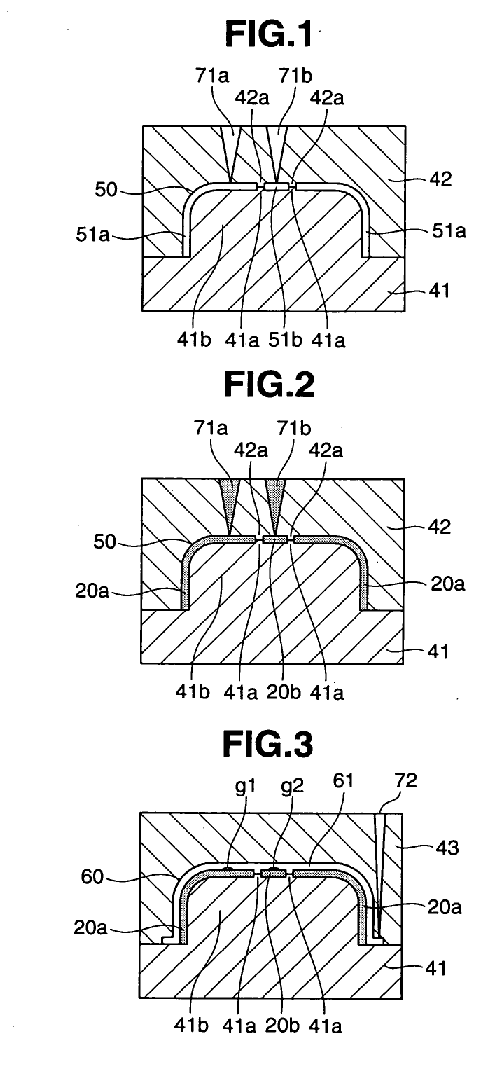

FIGS. 1 to 4 show the procedures of the double color-molding method according to this embodiment. In these figures, 41 is a lower metal mold which is used for both a first shot and a second shot, 42 is an upper metal mold which is used for a first shot, and 43 is an upper metal mold which is used for a second shot. The lower metal mold 41 is a metal mold for injection-molding a back surface of a key top and comprises a core 41b, which is in a convex shape from a cross-sectional viewpoint. On a front surface of the core 41b, a convex portion 41a is provided corresponding to a planer pattern of a closed loop in a letter, figure, mark, etc., to be formed on the key top.

The upper metal mold 42 is a mold for injection-molding a light-shielding resin layer at the time of a first shot, and has a cavity 50, which is in a concave shape from a cross-sectional viewpoint. The cavity 50 comprises a convex portion 42a formed in a pattern substantially corresponding to a planar pattern of the convex portion 41a. Further, the cavity 50 comprises a gate hole (resin injection hole) 71a for injecting light-shielding resin into an outer part that forms an outer line of a closed loop in a letter, figure, mark, or etc., and a gate hole (resin injection hole) 71b for injecting light-shielding resin into an inner part that forms an inner line of the closed loop.

As shown in FIG. 1, when the lower metal mold 41 and the upper metal mold 42 are compression-bonded in a state in which both metal molds are closed under adequate pressure, the convex portion 41a and the convex portion 42a are adhered together without gaps, and a space 51a for injection-molding the outer part that forms an outer line of the closed loop, and a space 51b for injection-molding the inner part that forms an inner line of the closed loop, are formed between the core 41b and the cavity 50.

Next, as shown in FIG. 2, in the first shot, when melt light-permeable resin is injected into the gate holes 71a and 71b, spaces 51a and 51b are filled with the light-permeable resin. Since the convex portion 41a and the convex portion 42a are adhered together under adequate pressure, the light-shielding resin does not flow in between the convex portion 41a and the convex portion 42a. When this light-shielding resin is cooled and solidified, the light-shielding resin that has filled in the space 51a and the space 51b becomes a light-shielding layer 20a and a light-shielding layer 20b, respectively. A preferable example of such light-shielding resin is,ABS resin of a blackish color.

FIG. 5 is a plane view of a light-shielding resin layer formed in the first shot (a half-finished product). The light-shielding resin layer 20a forms an outer line of a numeral “0,” and also constitutes an outer part of the light-shielding resin layer 20. On the other hand, the light-shielding resin layer 20b forms an inner line of the numeral “0” and constitutes an inner part of the numeral “0.” The light-shielding resin layer 20b is set in a hollow portion of the light-shielding resin layer 20a, separated by a gap in a shape of a closed curve, which is defined between both parts of the layer, and which forms a closed loop 21. The planar shape of the closed loop 21 corresponds to the numeral “0.” Since there is no bridge between the light-shielding resin layer 20a and 20b to connect both parts of the layer, when the numeral “0” is lit up, a problem, in which a bridge causes a shadow, does not arise.

When the first shot has been completed, the lower metal mold 41 and the upper metal mold 42 have been opened, a gate-cut has been performed on solidified light-shielding resin layer 20a and 20b, and the upper metal mold 42 for a first shot has been replaced with an upper metal mold 43 for a second shot, then the state becomes as shown in FIG. 3. Resin injection gates of the light-shielding resin layer 20a and 20b comprise gate traces g1 and g2, respectively. The upper metal mold 43 for a second shot comprises a cavity 60 for injection-molding light-permeable resin, which is in a concave shape from a cross-sectional viewpoint, and a gate hole 72 for injecting light-permeable resin into the cavity 60. When the lower metal mold 41 and the upper metal mold 43 are compression-bonded in a state in which both are closed under adequate pressure, a space 61 for injection-molding a light-permeable resin layer remains between the cavity 60 formed on the upper metal mold 43 and the lower metal mold 41.

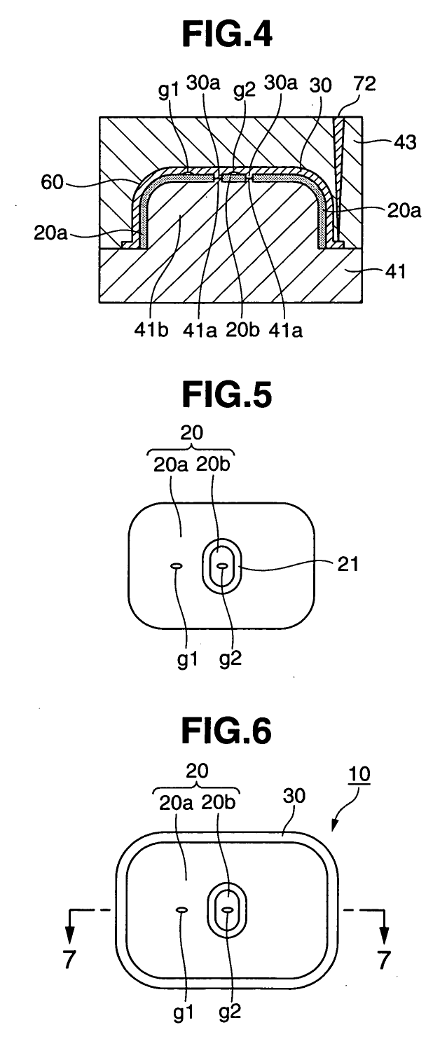

Next, as shown in FIG. 4, when melt light-permeable resin is injected from the gate hole 72 to fill the inside of the space 61, surfaces of the gate traces g1 and g2 are covered with light-permeable resin. A preferable example of light-permeable resin is a light-permeable chromatic resin having optical characteristics of selectively allowing an emission wavelength of a backlight through and absorbing the other wavelengths, and, of the surface of the substrate (light-shielding layer 20a and 20b) being hard to see when not illuminated by the back light. A preferable example of such light-permeable chromatic resin is resin in a color substantially corresponding to the color of the light source. For example, the back light is in red, a transparent dark red resin, etc., is preferable.

When the light-permeable resin is cooled and solidified, a light-permeable resin layer 30, which is melt-welded on a front surface of the light-shielding resin layer 20, is formed. At this time, gate traces g1 and g2 are completely covered by the light-permeable resin layer 30, and therefore, when the back light is off, gate traces g1 and g2 are hardly visible. Further, the light-permeable resin that has flowed in a concave portion between the light-shielding resin layer 20a and 20b (the closed loop in FIG. 5) is cooled and solidified to become a convex portion 30a. The convex portion 30a is sandwiched between the light-shielding resin layer 20a and 20b under an adequate pressure, the bonding force between the light-shielding resin layer 20 and the light-permeable resin layer 30 is enhanced. A height of the convex portion 41a is made to be approximately half a thickness of the light-shielding resin layer 20a and 20b, so that a height of the convex portion 30a can be made to be substantially the same as the height of the convex portion 41a. In this way, when the upper metal mold 43 and the lower metal mold 41 are opened, the separation of the light-shielding resin layer 20a and 20b, and the light-permeable resin layer 30, due to the light-shielding resin layer 20a and 20b sticking to the core 41b, can be prevented.

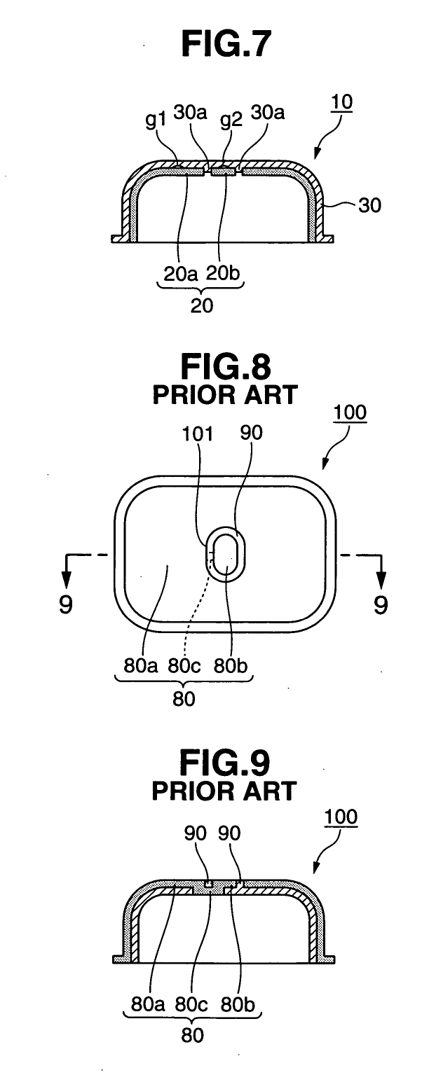

FIG. 6 is a plane view of a key top 10 molded by the second shot, and FIG. 7 is a cross-sectional diagram along the line 7-7 of FIG. 6. As shown in these figures, the light-permeable resin layer 30 is injection-molded in such a manner that it covers the entire surfaces of the closed loop 21 and the light-shielding resin layer 20. The gate traces g1 and g2 remain in the light-shielding resin layer 20a and 20b after the gate-cut, and these gate traces g1 and g2 are covered with the light-permeable layer 30. As described above, the light-permeable resin layer 30 comprises a light-permeable chromatic resin that allows only an emission wavelength of a back light through, and therefore, when the light is off, the gate traces g1 and g2 are hardly visible.

As explained above, according to this embodiment, the double-color molding of a key top can be achieved without any complicated metal mold. Further, there is no bridge passing behind the closed loop in a letter, figure, mark, etc., a problem of a poor quality image can be prevented. Furthermore, by covering the surface of a gate trace of a light-shielding resin layer with a light-permeable chromatic resin layer, the gate trace can be made inconspicuous, thereby achieving a design advantage.

We claim:

1. A method of double color-molding a key top, comprising the steps of:
performing a first shot for injection-molding with light-shielding resin an outer part that forms an outer line of a closed loop in a letter, figure, mark, or the like, and an inner portion that forms an inner line of said closed loop;
performing a gate-cut of an injection gate for light-shielding resin in both said outer potion and said inner part; and
performing a second shot for injection-molding a light-permeable resin layer that contacts a front surface of each of said outer part and said inner part in such a manner that said light-permeable resin layer covers a gate trace on both said outer part and said inner part, which remains after said gate-cut.

2. A method of double color-molding a key top comprises the steps of:
closing an upper metal mold for a first shot including a plurality of gate holes, which are arranged so that they are connected to a cavity, for injecting light-shielding resin into an outer part that forms an outer line of a closed loop in a letter, figure, mark, or the like, and into an inner part that forms an inner line of said closed loop, and a lower metal mold having a core, which includes a convex portion that corresponds to a planer shape of said closed loop;
performing a first shot for injecting light-shielding resin through said plurality of gate holes into a space remaining between said cavity of said upper metal mold and said core of said lower metal mold to injection-mold said inner part and said outer part;
opening said upper metal mold for a first shot and said lower metal mold;
performing a gate cut of an injection gate for light-shielding resin in both said outer part and said inner part;
changing said upper metal mold for a first shot to an upper metal mold for a second shot;
closing said upper metal mold for a second shot and said lower metal mold; and
performing a second shot for injecting light-permeable resin into a space remaining between a cavity of said upper metal mold for a second shot and said lower metal mold to injection-mold a light-permeable resin layer in such a manner that it covers a gate trace in both of said inner part and said outer part, which remains after said gate-cut.

3. A method of double color-molding a key top according to claim 2, wherein a height of said convex portion formed on said core of said upper metal mold for a first shot is approximately half of a thickness of said inner part or said outer part.

4. A method of double color-molding a key top according to any one of claims 1 through 3, wherein said light-permeable resin layer is a light-permeable chromatic resin layer that selectively allows a wavelength of a back light through.
